(19) United States
(12) Patent Application Publication
(10) Pub. No.: US 2006/0020063 A1
(43) Pub. Date: Jan. 26, 2006

(54) Controlled finishes for free surface polyethylene resins

(76) Inventors: Gerhard K. Guenther, Seabrook, TX (US); Steven D. Gray, League City, TX (US); Tim J. Coffy, Houston, TX (US); G. Travis Meredith, Pearland, TX (US)

Correspondence Address: FINA TECHNOLOGY INC, PO BOX 674412, HOUSTON, TX, 77267-4412, US

(21) Appl. No.: 10/896,713

(22) Filed: Jul. 22, 2004

(51) Int. Cl. C08K 5/49

(52) U.S. Cl. 524/115

(57) ABSTRACT

It has been discovered that the amount of fluoropolymer additive used in a polyethylene resin affects the quality of finish of an article made with free surface polyethylene resins using chromium, Ziegler-Natta or metallocene catalysts. Reducing the amount of fluoropolymer increases the matte nature of the polymer finish, whereas increasing the amount of fluoropolymer increases the gloss nature of the finish. Introducing a peroxide or air in an increasing amount increases the long chain branching (LCB) of the polymer. Introducing an antioxidant in an amount to balance the peroxide amount can improve the melt strength of the polymer, and the amount of antioxidant is balanced with the amount of peroxide and/or air. The resultant polymer density ranges between about 0.960 and 0.962 g/cm³ inclusive, where the molecular weight distribution (MWD) of the polymer is greater than 3 and less than 6.

### FIELD OF THE INVENTION

The present invention relates to processes and resins for the preparation of polyethylene articles having a controlled finish, and more particularly relates, in one embodiment, to processes and resins for the preparation of narrow molecular weight distribution (MWD) high density polyethylene (HDPE) articles having a controlled finish ranging from gloss to matte.

### BACKGROUND OF THE INVENTION

Polyethylene has been used in the production of a very wide variety of articles including, but not necessarily limited to, sheets, films, and blow-molded products, such as bottles. Examples of such blow-molded products include household industrial containers, such as bleach bottles, detergent bottles and the like. Blow molding is accomplished by extruding molten polyethylene resin as a parison or hollow tube into a mold cavity while simultaneously forcing air into the parison so that the parison expands, taking on the shape of the mold. The molten polyethylene cools within the mold until it solidifies to produce the desired molded product.

It is desirable to be able to control the surface finish of the blow-molded article. For some blow-molding applications, high gloss in the blow-molded article is desirable for aesthetics, clarity and the feel of the article. Unimodal Ziegler-Natta resins are known to have relatively narrow molecular weight distributions (MWD or polydispersity M_{w}/Mₙ), which improves gloss and clarity. At the same time, the narrow MWD and the lack of long chain branching (LCB) for these resins make a resin that is difficult to process due to low melt strength, low swell, and a poor shear response. Low melt strength can lead to difficulty in the molding process because the parison can sag too much leading to poor wall distribution and thickness control. In addition, the low swell of these resins can make it difficult to fill the mold.

In other blow-molding applications, a matte surface finish is desirable for a different, “quality” or “richer” feel and look. Some of these applications include, but are not necessarily limited to, tool boxes, storage containers, liquid containers, and the like. Often, surface finish in blow molding is controlled by the mold surface finish. However, as noted, the inherent resin gloss plays a significant role.

When light reflects from a polyolefin article, scattering can cause the light to deviate from the incident direction. If the scattering is significant enough, it will cause a reduction in the reflected light and the sample will have a matte appearance. This scattering can be from surface imperfections that are generally related to low gloss, or from scattering bodies within the object itself. In the case of polyethylene, the scattering bodies are from the regions of high crystalline polymer that increase as the polymer density increases. Increasing the polymer density can be achieved by increasing both the size and quantity of crystalline lamella at the expense of the amorphous polyethylene. Therefore, it is normal to observe reduced clarity as haze increases as a function of density of conventional polyethylene blown film. Gloss is a function of the surface texture not density.

It would be desirable if the surface finish of blow-molded and other narrow MWD polyethylene articles could be easily controlled, particularly over a range from a clear, glossy finish to a matte finish. Tailoring the properties of polyolefin resins to fit a desired application or end use is a constantly ongoing endeavor.

### SUMMARY OF THE INVENTION

In carrying out these and other objects of the invention, there is provided, in one form, a process for controlling the finish of free surface polyethylene resins, involving providing a polyethylene resin having a molecular weight distribution (MWD) greater than about 3 and less than about 6, and controlling the finish of the ultimate polymer by adjusting the proportion of (i) a peroxide and/or air, (ii) an antioxidant, and (iii) optionally fluoropolymer in the resin during an extrusion or compounding step. Introducing a peroxide or air in increasing amount into the resin increases the long chain branching (LCB) of the polymer. LCB improves the melt strength. Introducing an antioxidant into the resin in an amount to balance the peroxide and/or air amount improves the melt stability of the polymer. Introducing a fluoropolymer into the resin affects the finish of the resulting polymer where reducing the amount of fluoropolymer increases the matte nature of the polymer finish due to melt fracture, and increasing the amount of fluoropolymer increases the gloss nature of the polymer finish due to a reduction in the melt fracture. Optionally, the resultant polymer density ranges between 0.910 and 0.962 g/cm³.

In another embodiment of the invention, there is provided a finish-modified polyethylene resin having molecular weight distribution (MWD) of the polymer is greater than 3 and less than 6, a peroxide and/or air, and an antioxidant, where the amounts of peroxide and/or air and antioxidant are effective to change the surface finish of the resulting polyethylene as compared with a similar polyethylene absent the peroxide and/or air and antioxidant. In yet another embodiment of the invention, there are provided products from these polyethylene resins, particularly blow-molded articles made from these resins.

### BRIEF DESCRIPTION OF THE DRAWINGS

FIG. 1 is a chart of gloss results at 45° for films from polyethylene resins of various formulations; and

FIG. 2 is a chart of % haze results for 1 mil (0.0254 mm) films from the polyethylene resins of the formulations of FIG. 1.

### DETAILED DESCRIPTION OF THE INVENTION

The present invention is directed to free surface applications of polyethylene resins in one embodiment, and in a particular embodiment high density polyethylene (HDPE), HDPE blow-molded articles, and methods and systems for producing HDPE blow-molded articles. The polyethylene resins of this invention may be applied in any “free surface” application, by which is meant any extrusion/molding process where the polymer exits a die and is for a brief period unconstrained before being molded or formed into a product. Thus, free surface applications include, but are not necessarily limited to, film blowing and extrusion, sheet extrusion, blow-molding, coating, etc. In one non-limiting embodiment, the HDPE resin of the present invention is a medium molecular weight HDPE (MMW-HDPE) homopolymer having a narrow molecular weight distribution (MWD), a highly linear backbone, low shear thinning behavior, and is extremely well suited for producing high density blow-molded articles. In addition, the linear HDPE homopolymer of the invention contains extremely low levels of catalyst residues, thus allowing a virgin powder to be extruded into readily handled pellet form without significant polymer degradation and/or formation of long chain branches. However, as will be explained, long chain branching (LCB) is desirable for other reasons. Typically, narrower MWD and lower LCB give a higher gloss. When gloss is high, the haze is low and the clarity is high because the light is not scattered. A combination of high gloss and low density gives a higher clarity and a lower haze. The base resin of this invention is very similar to those film grade resins described in U.S. patent application Ser. Nos. 09/896,917 and 09/896,916, both filed Jun. 29, 2001, hereby incorporated by reference.

Generally the MWD of the HDPE of the invention is less than about 6, and greater than about 3, inclusive. In one non-limiting alternative of the invention, the MWD is less than about 5 and in another non-limiting embodiment the MWD is greater than about 4. In one non-limiting embodiment of the invention, the density of the HDPE of the invention may be between 0.960 and 0.962 g/cm³, inclusive, and in another non-limiting, alternate embodiment of the invention between 0.910 and 0.962 g/cm³. The inventive concept is generally independent of density. In the context of this invention, the MWD refers to the MWD of a unimodal resin, or in the case of a bimodal resin refers to the MWD of the high molecular weight component thereof. The HDPE generally has a MI2 in the range of about 0.2 dg/min to about 5.0 dg/min, in one non-limiting, alternate embodiment of the invention from about 0.7 dg/min to about 3.0 dg/min, and in a further nonlimiting, alternate embodiment of the invention from about 0.8 dg/min to about 2.5 dg/min.

The HDPE of the invention is stable upon extrusion and has a rheological breadth parameter “a” greater than conventional HDPE resins. For resins with no differences in levels of long chain branching (LCB), it has been observed that the Theological breadth parameter “a” is inversely proportional to the breadth of the molecular weight distribution. Similarly, for samples that have no differences in the molecular weight distribution, the breadth parameter “a” has been found to be inversely proportional to the level of long chain branching. An increase in the rheological breadth of a resin is therefore seen as a decrease in the breadth parameter “a” value for that resin. This correlation is a consequence of the changes in the relaxation time distribution accompanying those changes in molecular architecture. Generally, the HDPE resin of the invention has a rheological breadth parameter “a” of greater than about 0.08, and in another non-limiting, alternate embodiment of the invention, greater than about 0.25, and on the other hand greater than about 0.30. Depending on starting material, the breadth parameter could range between 0.05 and 0.6. Rheological breadth parameter “a” is defined in more detail below.

Another embodiment of the invention provides a process for polymerization of α-olefin monomers, wherein the monomers are generally ethylene. The polymerization process of the invention may be bulk, slurry or gas phase, although in one non-limiting embodiment of the invention, a slurry phase polymerization is used, and in another non-limiting, alternate embodiment a loop reactor may be employed.

It is preferred that the virgin resins of the invention have an extremely low level of catalyst residues in order to avoid degradation upon extrusion. The production conditions described below, which favor strong forward polymerization, are key to increasing catalyst activity and limiting catalyst residues in the ultimate product.

In order to generate highly linear polymer, the polymerization conditions utilized herein strongly favor the forward polymerization of ethylene and minimize the possibility of termination of the growing polymer chain via beta-hydrogen elimination. Employing a high ethylene concentration in the polymerization process, as well as use of high reactor temperatures, creates such an environment. Generally the ethylene concentration used herein is in a range of about 1.0% to about 10.0%, in another non-limiting, alternative embodiment, about 3.0% to about 8.0%. The reactor temperature is generally a temperature in the range of about 180° F. to about 230° F. (about 82 to about 110° C.). In another non-limiting, alternative embodiment of the invention, the reactor temperature is in the range of about 190° F. to about 225° F. (about 88 to about 107° C.), and in yet another nonlimiting, alternative in the range of about 200° F. to about 220° F. (about 93 to about 104° C.). The use of aluminum cocatalyst levels, generally in the range of about 10 ppm to about 300 ppm with respect to the diluent, also appears to inhibit elimination pathways leading to LCB. In one non-limiting embodiment of the invention, the cocatalyst levels are in the range of about 50 ppm to about 200 ppm with respect to the diluent, and in another non-limiting embodiment are in the range of about 25 ppm to about 150 ppm.

The olefin monomer may be introduced into the polymerization reaction zone in a nonreactive heat transfer diluent agent that is liquid at the reaction conditions. Examples of such a diluent include, but are not necessarily limited to, hexane and isobutane. In one non-limiting embodiment of the invention, the diluent is isobutane.

Generally the polymer produced herein is a homopolymer. However, for copolymerization of ethylene with another alpha-olefin, such as, for example, butene or hexene, the second alpha-olefin may be present at about 0.01-20 mole percent, in another non-limiting embodiment from about 0.02-10 mole percent.

In one non-limiting embodiment of the invention, the catalyst system employed herein should behave in a controlled manner under the aggressive reactor conditions needed to ensure high activity. Generally the activity/productivity of the catalyst used herein is greater than about 30,000 gPE/g catalyst, in another nonlimiting embodiment of the invention, is greater than about 40,000 gPE/g, and in one other non-limiting, alternate embodiment of the invention is greater than about 50,000 gPE/g. The catalyst system should not only behave well chemically, but it must have physical properties allowing even flow of the suspended catalyst to the reactor to be readily achieved. Catalysts with a well-defined size and shape (i.e. overall morphology) assist in maintaining steady reaction at the vigorous production conditions needed. The bulk morphology of the polymer produced is a function of the catalyst and is also important. The morphology of the polymer produced must be amiable to the particular production process employed. For example, a loop process, in which polymer is removed from the reactor via settling legs and the morphology of the product (size, shape, bulk density, uniformity) has a significant effect on the maximum allowable slurry concentration and, in turn, the overall residence time and productivity of the catalyst system.

It has been discovered that the finish of HDPE articles made from the resins of this invention can be controlled by the proportion of certain components. The HDPE articles of this invention may possess exceptional clarity (i.e., low haze) and gloss in comparison to conventional high density polyethylene films, or alternatively may have an intentional matte finish to give a “quality” look and feel to the article. Unimodal Ziegler-Natta resins have relatively narrow MWDs, which improves gloss and clarity. At the same time, the narrow MWD and the lack of long chain branching (LCB) for these conventional resins gives a resin that is difficult to process due to low melt strength, low swell and a poor shear response. Low melt strength can lead to difficulty in the molding process because the parison can sag too much, leading to poor wall distribution and thickness control. In addition, the low swell of these resins can make it difficult to fill mold features such as handles.

It has been discovered that a resin additive such as peroxide and/or air alone or together with an antioxidant or a modified antioxidant package can provide the necessary LCB needed to make a more processable material, while at the same time not sacrifice the gloss and clarity. In one non-limiting embodiment of the invention, the peroxide proportion ranges from about 2 to about 100 ppm by weight, based on the total resin. In an alternate non-limiting embodiment, the peroxide proportion may range from about 10 to about 100 ppm, alternatively from about 30 to about 60 ppm by weight, based on the total resin. In one nonlimiting embodiment of the invention, the antioxidant proportion ranges from about 300 to about 3,000 ppm by weight, based on the total resin. In an alternate nonlimiting embodiment, the antioxidant proportion may range from about 1000 to about 2000 ppm by weight, based on the total resin. Within the context of this invention, a “modified” antioxidant may be defined as one where the ratio of phenolic to phosphite is changed or the total level of antioxidant functionality is changed, compared to what is conventionally used.

In one non-limiting embodiment of the invention, suitable peroxides include, but are not necessarily limited to, hydrogen peroxide, air, oxygen, generally any free radical initiator such as LUPERSOL® 101 (available from ATOFINA Petrochemicals) or oxygen. In one non-limiting embodiment of the invention, suitable antioxidants include, but are not necessarily limited to, phenolics and phosphites such as Irganox 1010 (phenolic antioxidant) and Irgafos 168 and Ultranox 627A (phosphite antioxidants), all available from Ciba-Geigy.

It should be understood that antioxidants and peroxides and/or air are to be employed as a balance or trade-off because they have opposite effects, and should generally be employed in pairs to maintain control of the resin characteristics and ultimate finish on the article. Increasing the peroxide proportion will increase LCB, while introducing an antioxidant improves the melt or thermal stability of the polymer. These goals can be achieved with the method of this inventtion while maintaining high gloss. The balance of peroxide and/or air to antioxidant is controlled or determined by a sufficient level of LCB (from peroxide or air) while maintaining sufficient melt stability for subsequent processing.

Within the context of this invention, “high gloss” is defined as a 45 degree gloss value of greater than about 20%, in an alternate, non-limiting embodiment of the invention greater than about 30%, and in another non-limiting embodiment greater than about 40%. Furthermore, a matte finish is defined as having a gloss value of less than about 20% or less. In an alternate, non-limiting embodiment of the invention less than about 10%, and in another non-limiting embodiment less than about 5%.

Typically, the surface finish of a blow-molded article is controlled by the mold surface finish. However, the inherent resin gloss plays a significant role as discussed. Another aspect of the invention is to provide a very matte surface finish utilizing the melt fracture characteristics of narrow molecular weight distribution resins. Since narrow MWD resins (such as Ziegler-Natta and metallocene resins) are sometimes compounded with fluoropolymer to eliminate melt fracture, in the subject invention, little or no fluoropolymer is added to insure a controlled melt fracture or “shark skin” (matte) surface. The inventive resin may or may not require more melt strength, which could be improved using free radical initiators such as peroxides or air and/or by using a low level antioxidant package to induce long chain branching, as mentioned.

Suitable fluoropolymers in the method of this invention include but are not necessarily limited to, Dynamar FX 9613, FX 5914X, FX5911, FX 5912X, FX5920A, FX 5921X, FX 5922X available from 3M, as well as Viton GB, SC, Z100 and Z200 available from DuPont Dow Elastomers L.L.C. In the case where a gloss finish is desired, the fluoropolymer proportion may range from about 25 to about 2000 ppm by weight, based on the total resin. In another non-limiting embodiment, the lower threshold is above about 50 ppm, and alternatively above about 100 ppm. In an alternative, non-limiting embodiment of the invention, the fluoropolymer proportion may range from above about 200 to about 1500 ppm, and alternatively from about 300 to about 800 ppm by weight, based on the total resin. In the case where a matte finish is desired, the fluoropolymer proportion may range from 0 to about 300 ppm by weight, based on the total resin. In an alternative, non-limiting embodiment of the invention, the fluoropolymer proportion may range from 0 to about 200 ppm, and alternatively range from 0 to about 100 ppm by weight, based on the total resin, and in another non-limiting embodiment from 0 to about 50 ppm. It will be noted that the fluoropolymer ranges to produce matte and gloss finishes overlap. This is because the finish is not determined solely by the fluoropolymer proportion, but also other parameters including, but not necessarily limited to the amount of peroxide and/or air used and the amount of antioxidant employed.

In the method of the invention, a free radical initiator is added to the polyethylene resin prior to extrusion. The free radical initiator, as used herein, is that which results in light crosslinking or branching of the polyethylene molecules. Such free radical initiators include peroxides, oxygen, air and azides, such as those described previously, as well as those of U.S. Pat. No. 6,433,103, incorporated by reference herein.

The choice of peroxide may vary, however, depending upon the particular application and extruder temperatures encountered. Typical extruder temperatures are from about 350° F. (177° C.) to about 550° F. (288° C.). It is important that the extruder temperature or polyethylene melt be above the decomposition temperature of the peroxide. Thus, extruder temperatures will typically be at least 5% or higher than the decomposition temperature of the peroxide being used to ensure complete decomposition. The extruder temperature can be determined using a combination of peroxide half life versus temperature data and the residence time in the extruder as prescribed by the desired throughput.

The peroxide and/or air and the antioxidant, and the optional fluoropolymer, can be added to the polyethylene fluff or powder prior to introduction into the extruder. For polyethylene fluff having a MI2 of 1.0 or greater, in some non-limiting embodiments, these components may be added to the fluff prior to extrusion. In such cases, the peroxide/air, antioxidant or fluoropolymer should be thoroughly mixed or dispersed throughout the polymer before being introduced into the extruder. Alternatively, the components can be injected into the polyethylene melt within the extruder. The additives may be added as a liquid, although the components may be added in other forms as well, such as a gas or as a peroxide coated solid delivery. The additives may also be added or combined with the polyethylene prior to or after the polyethylene is fed into the extruder. It is preferable to add liquid peroxide to the melt phase of the polyethylene within the extruder to ensure that the peroxide is completely dispersed. The additives may be introduced into the extruder through any means known to those skilled in the art, such as by means of a gear pump or other delivery device. If oxygen or air is used as the initiator, these may be injected into the extruder within the polyethylene melt in one non-limiting embodiment.

In contacting the polymer with these components, it may be desirable for the peroxide to be as evenly dispersed as possible in order to prevent the occurrence of high local concentrations of free radicals. While it would be desirable to have a perfect dispersion of peroxide or other initiator, in practice, a perfect dispersion is not possible and has been found not to be critical. Preferably, the peroxide is blended as completely as possible, but moderate blending of the peroxide with the resin has been effective. Insufficient mixing can result in a resin with improved processing properties but having other undesirable effects, such as gel formation, which can reduce the commercial value of the resin.

As is known in the art for improving processability of a polymer, a processing aid such as, for example, Viton GB, Viton SC, Dynamar FX9613, FX5911, any fluoroelastomer, any other fluoropolymer, and any of the other equivalent materials known by one of skill in the art, may be included in the polymer composition to be blown on the film line. Processing aids initiate slip between tooling and the polymer and thus allows for the extrusion of a smooth surface (and therefore a glossy surface) regardless of LCB content. Such processing aids and specifications of their use are known in the art.

In addition, the resins of the films of the invention may comprise any of the other processing additives known in the art such as, heat stabilizers, weather stabilizers, lubricants, etc, in amounts that do not adversely affect to a significant extent the goals, objectives and/or desirable characteristics of the present invention. These processing aids and the specifications of using such aids are well known in the art.

For producing an article of the invention using co-extrusion methods, it is within the scope of the present invention to blend the HDPE of the invention with other polymers, so long as the amount of the other polymers does not unduly detract from the beneficial properties desired in the final product including, but not necessarily limited to, the desired finish and good processability of the HDPE of the invention. Thus, the HDPE of the invention may be about 0.1 to about 99.9 weight percent of the polymer blend.

As discussed above, the polyolefin catalysts utilized herein exhibit very high activity that is at least partially dependent upon the olefin polymerization conditions, and provide a polymer with excellent fluff morphology. Thus, the catalysts useful in the present invention provide for large polymer particles having a uniform distribution of sizes, wherein the average resin particle size is between about 200 to about 400 microns, and small, extremely fine particles (less than about 125 microns) are only present in low concentrations.

In one non-limiting embodiment, the polyethylene is preferably that produced from chromium catalysts capable of producing the narrow molecular weight distribution polyethylene discussed above. The chromium catalysts that are used are those that are well known to those skilled in the art. Activated chromium catalysts on a silica or titanium oxide support are particularly well suited to the polymerization of ethylene for blow molding resins. Increased rheological breadth of polyethylene produced from other catalysts used in the polymerization of olefins, such as Ziegler-Natta, metallocene or late-transition metal catalysts can be obtained as well.

As mentioned, catalysts employed in the processes of this invention may be conventional chromium catalysts obtained by depositing a chromium compound onto an inorganic support material having surface hydroxyl groups. Known chromium containing compounds capable of reacting with the surface hydroxyl groups of the support material are employed. The chromium-containing support is generally activated by heating at a temperature above about 450° F. (232° C.) but below the decomposition temperature of the support. The activated supported chromium catalyst is typically combined with a metal and/or non-metal reducing agent, preferably a boron containing compound, for use in the polymerization process.

Inorganic supports which are useful include those normally employed to support catalysts. Typically, these supported materials are inorganic oxides of silica, alumina, silica-alumina mixtures, thoria, zirconia and comparable oxides which are porous, have a medium surface area, and have surface hydroxyl groups. Silica xerogels which have surface areas in the range of 200 to 500 m²/g and pore volumes greater than about 2.0 cc/g are highly useful.

Chromium compounds which can be used include any chromium containing compound capable of reacting with the surface hydroxyl groups of an inorganic support. Examples of such compounds include chromium trioxide, chromium nitrate, chromate esters such as the hindered di-tertiary polyalicyclic chromate esters, chromium acetate, chromium acetylacetonate, t-butyl chromate, silyl chromate esters and phosphorus containing chromate esters, organophosphoryl chromium compounds, and organochromium compounds such as chromocene. The latter compounds are the reaction product of chromium trioxide with an organophosphorus compound. Trialkyl phosphates, such as triethyl phosphate, are especially useful organophosphorus compounds for this purpose.

Aluminum compounds are commonly included with the chromium compound in the preparation of useful catalysts. Any aluminum compound capable of reacting with the surface hydroxyl groups of the inorganic support material can be used. Highly useful aluminum compounds correspond to the formula:
Al(X)ₐ(Y)_{b}(Z)_{c}
wherein X is R, Y is OR and Z is H or a halogen; a is 0-3, b is 0-3, c is 0-3, and a+b+c equals 3; and R is an alkyl or aryl group having from one to eight carbon atoms.

Examples of such aluminum compounds include aluminum alkoxides such as aluminum sec-butoxide, aluminum ethoxide, aluminum isopropoxide; alkyl aluminum alkoxides such as ethyl aluminum ethoxide, methyl aluminum propoxide, diethyl aluminum ethoxide, diisobutyl aluminum ethoxide, etc.; alkyl aluminum compounds such as triethyl aluminum; triisobutyl aluminum, etc.; alkyl or aryl aluminum halides such as diethyl aluminum chloride; aryl aluminum compounds such as triphenyl aluminum, aryloxy aluminum compounds such as triphenyl aluminum, aryloxy aluminum compounds such as aluminum phenoxide and mixed aryl, alkyl and aryloxy, alkyl aluminum compounds.

The aluminum cocatalysts noted above can also be used as cocatalysts together with metallocene catalysts useful for the production of polyethylene and copolymers of alpha-olefins with ethylene.

The catalysts useful in producing the resins of the present invention may be any Ziegler-Natta catalyst known in the art for the polymerization of polyethylene. Ziegler-Natta catalysts especially useful in the polymerization processes of the invention include the Ziegler-Natta catalysts disclosed in U.S. Pat. No. 6,174,971, issued Jan. 16, 2001 to Chen et al., and those disclosed in the following co-pending applications: U.S. patent application Ser. No. 09/687,378, entitled “Ziegler-Natta Catalyst For Tuning MWD of Polyolefin, Method of Making, Method of Using, and Polyolefins Made Therewith, filed October 13, 2000; U.S. Pat. No. 6,486,274, entitled “Improved Hydrogen Response Ziegler-Natta Catalyst for Narrowing MWD of Polyolefin, Method of Making, Method of Using, and Polyolefins Made Therewith”, issued Nov. 26, 2002; and U.S. patent application Ser. No. 09/687,560 entitled, “Ziegler-Natta Catalyst for Narrow to Broad MWD of Polyolefins, Method of Making, Method of Using, and Polyolefins Made Therewith”, all of which are incorporated herein by reference.

The following examples serve to merely to illustrate certain embodiments of the present invention, but are not intended to limit the invention in any way.

The properties of the HDPE polymer and films of the invention would be obtained using methods known in the art as follows:

Molecular Weight and Polydispersity (MWD)

The molecular weights M_{w} and Mₙ and the resultant polydispersity (MWD=M_{w}/Mₙ) would be measured by gel permeation chromatography (GPC).

Density

The density would be determined in accordance with ASTM D1505 or ASTM D792.

Rheological Breadth Parameter

The rheological breadth parameter is a function of the relaxation time distribution of the resin, which in turn is a function of a resin's molecular architecture. The breadth parameter is experimentally determined assuming Cox-Merz rule by fitting flow curves generated using linear-viscoelastic dynamic oscillatory frequency sweep experiments with a modified Carreau-Yasuda (CY) model,
η=η_{B}[1+(λγ)^{a}]^{(n-1)/a} (1)
where η=viscosity (Pa-s), γ=shear rate (1/s), a=rheological breadth parameter (CY model parameter which describes the breadth of the transition region between Newtonian and power law behavior), λ=relaxation time sec (CY model parameter which describes the location in time of the transition region), η_{B}=zero shear viscosity (Pa-s) (CY model parameter which defines the Newtonian plateau), and n=power law constant (CY model parameter which defines the final slope of the high shear rate region).

To facilitate model fitting, the power law constant (n) is held to a constant value (n=0). Experiments are typically carried out using a parallel plate geometry and strains within the linear viscoelastic regime over a frequency range of 0.1 to 316.2 sec⁻¹. Frequency sweeps would be performed at three temperatures (170° C., 200° C. and 230° C.) and the data would be shifted to form a master-curve at 190° C. using known time-temperature superposition methods.

Melt Index, Haze and Gloss

The melt index would be determined in accordance with ASTM D1238, and gloss would be measured in accordance with ASTM D-2457-70.

### EXAMPLES 1-5

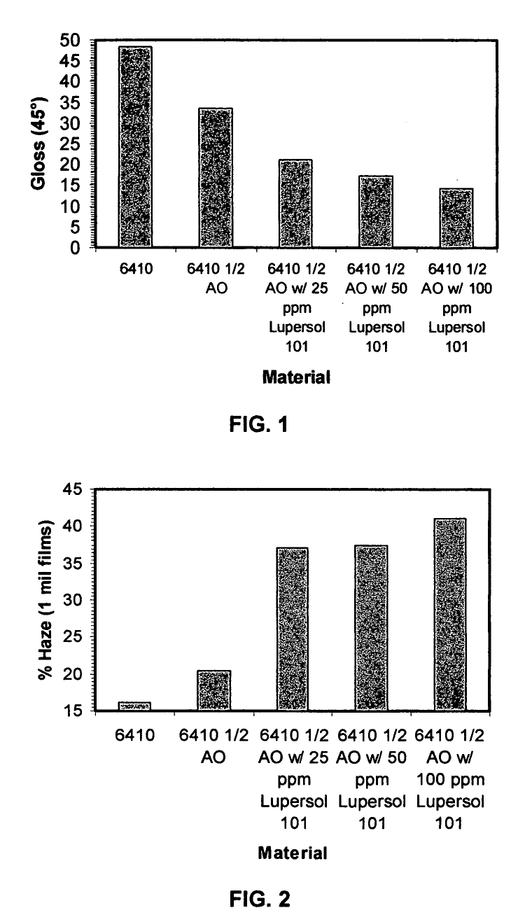

Five resins were prepared based upon FINATHENE® 6410 high density polyethylene resin, available from ATOFINA Petrochemicals, Inc. The gloss and haze properties of the produced 1 mil (0.0254 mm) films were measured as described above. The antioxidant used was a mixed phenolic/phosphate antioxidant package used at the level of 500 ppm for Examples 2-5. Various proportions of the peroxide LUPERSOL® 101 (available from ATOFINA Petrochemicals). The proportions of components are outlined in Table I as are the gloss and haze results which are also charted in FIGS. 1 and 2, respectively. It may be seen that both gloss and haze can be controlled by adjusting the levels of antioxidant and peroxide in accordance with the methods of this invention.

TABLE I

| Ex. | Resin and Additives | Haze (%) | Gloss (45°) |
|---|---|---|---|
| 1 | 6410 | 16.1 | 48.4 |
| 2 | 6410 + ½ AO | 20.5 | 33.5 |
| 3 | 6410 + ½ AO w/ 25 ppm Lupersol 101 | 37.1 | 21.2 |
| 4 | 6410 + ½ SO w/ 50 ppm Lupersol 101 | 37.4 | 17.4 |
| 5 | 6410 + ½ AO w/ 100 ppm Lupersol 101 | 41.0 | 14.3 |

In the foregoing specification, the invention has been described with reference to specific embodiments thereof, and has been demonstrated as effective in providing a method for controlling the finish (gloss or matte) of free surface polyethylene resins. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations or amounts of co-catalysts, peroxides, antioxidants, fluoropolymers and other components falling within the claimed parameters, but not specifically identified or tried in a particular ethylene polymerization system, are anticipated and expected to be within the scope of this invention. Further, the method of the invention is expected to work at other conditions, particularly temperature, pressure and concentration conditions, than those described herein.

We claim:

1. A process for controlling the finish of free surface polyethylene resins, comprising:
providing a polyethylene resin having a molecular weight distribution (MWD) greater than about 3 and less than about 6;
controlling the finish of the ultimate polymer by adjusting a proportion of (i) a peroxide or air, (ii) an antioxidant, and (iii) optional fluoropolymer in the resin, whereby:
introducing a peroxide and/or air in increasing amount effective to increase the long chain branching (LCB) of the polymer;
introducing an antioxidant in an amount to balance the peroxide amount effective to improve the melt stability of the polymer; and
introducing a fluoropolymer where
reducing the fluoropolymer by an amount effective to increase the matte nature of the polymer finish, and
increasing the fluoropolymer by an amount effective to increase the gloss nature of the polymer finish,

2. The process of claim 1 where in introducing the peroxide and/or air, the peroxide and/or air proportion ranges from about 2 to about 100 ppm by weight, based on the total resin.

3. The process of claim 1 where in introducing the antioxidant, the antioxidant proportion ranges from about 300 to about 3,000 ppm by weight, based on the total resin.

4. The process of claim 1 where in reducing the fluoropolymer to increase the matte nature of the polymer finish, the fluoropolymer proportion ranges from 0 to about 300 ppm by weight, based on the total resin.

5. The process of claim 1 where in increasing the fluoropolymer to increase the gloss nature of the polymer finish, the fluoropolymer proportion ranges from about 25 to about 2000 ppm by weight, based on the total resin.

6. The process of claim 1 where the polymer density is between about 0.910 and 0.962 g/cm³ and is the density if the resin is a unimodal resin or the density of the high molecular weight component if the resin is a bimodal resin.

7. The process of claim 1 where the polyethylene resin is a chromium-catalyst-produced polyethylene resin.

8. The method of claim 1, wherein the peroxide and/or air and antioxidant, and fluoropolymer if present, are added to the polyethylene resin while the polyethylene resin is in a molten state during extrusion.

9. The process of claim 1 where the balance of peroxide and/or air to antioxidant is determined by sufficient LCB from peroxide or air while maintaining adequate melt stability for subsequent processing.

10. The process of claim 1 where the resultant polymer has a rheological breadth parameter of greater than about 0.05.

11. The process of claim 1 further comprising blow molding the polyethylene resin.

12. The process of claim 1 further comprising sheet extruding the polyethylene resin.

13. The process of claim 1 further comprising coextruding the polyethylene resin with at least one additional resin.

14. The process of claim 1 where the resultant polymer has a gloss value of greater than about 20%.

15. The process of claim 1 where the resultant polymer has a gloss value of about 20% or less.

16. The process of claim 1 wherein said polyethylene is a homopolymer.

17. The process of claim 1, wherein the polyethylene resin comprises polyethylene and ethylene copolymers of C₃ to C₁₀ alpha-olefins.

18. A polyethylene product prepared by the method of claim 1.

19. A finish-modified polyethylene resin comprising a polyethylene resin having a molecular weight distribution (MWD) greater than about 3 and less than about 6, a peroxide and/or air, and an antioxidant, where the amounts of peroxide and/or air and antioxidant are effective to change the surface finish of the resulting polyethylene as compared with a similar polyethylene absent the peroxide and/or air and antioxidant.

20. The polyethylene resin of claim 19 where the resin comprises a peroxide and/or air proportion of from about 2 to about 100 ppm by weight, based on the total resin.

21. The polyethylene resin of claim 19 where the resin comprises an antioxidant proportion ranges from about 300 to about 3,000 ppm by weight, based on the total resin.

22. The polyethylene resin of claim 19 where the resin comprises a fluoropolymer proportion up to about 300 ppm by weight, based on the total resin, and the resin has a matte finish.

23. The polyethylene resin of claim 19 where the resin comprises a fluoropolymer proportion ranges from about 25 to about 2000 ppm by weight, based on the total resin, and the resin has a gloss finish.

24. The polyethylene resin of claim 19 where the density is between about 0.910 and 0.962 g/cm³ and is the density if the resin is a unimodal resin or the density of the high molecular weight component if the resin is a bimodal resin.

25. The polyethylene resin of claim 19 where the polyethylene resin is a chromium-catalyst-produced polyethylene resin.

26. The polyethylene resin of claim 19, wherein the peroxide and/or air and antioxidant are added to the polyethylene resin while the polyethylene resin is in a molten state during extrusion.

27. The polyethylene resin of claim 19 where in the resin the balance of peroxide and/or air to antioxidant is determined by sufficient LCB from peroxide or air while maintaining adequate melt stability for subsequent processing.

28. The polyethylene resin of claim 19 where the resultant polymer has a rheological breadth parameter of greater than about 0.05.

29. The polyethylene resin of claim 19 wherein said polyethylene is a homopolymer.

30. The polyethylene resin of claim 19, wherein the polyethylene resin includes polyethylene and ethylene copolymers of C₃ to C₁₀ alpha-olefins.

31. A polyethylene product prepared from the resin of claim 19.

32. A blow-molded article made from the resin of claim 19.

33. The blow-molded article of claim 32 where the article has a gloss value of greater than about 20%.

34. The blow-molded article of claim 32 where the article has a gloss value about 20 or less than.

35. A finish-modified polyethylene resin comprising a polyethylene resin having a molecular weight distribution (MWD) greater than about 3 and less than about 6, a peroxide and/or air proportion ranging from about 2 to about 100 ppm by weight, and an antioxidant proportion ranging from about 300 to about 3,000 ppm by weight, both based on the total resin, where the balance of peroxide and/or air to antioxidant is determined by sufficient LCB from peroxide or air while maintaining adequate melt stability for subsequent processing, wherein the peroxide and/or air and antioxidant are added to the polyethylene resin while the polyethylene resin is in a molten state during extrusion.

36. The polyethylene resin of claim 35 where the resin comprises a fluoropolymer proportion up to about 300 ppm by weight, based on the total resin, and the resin has a matte finish.

37. The polyethylene resin of claim 35 where the resin comprises a fluoropolymer proportion ranges from about 25 to about 2000 ppm by weight, based on the total resin, and the resin has a gloss finish.

38. The polyethylene resin of claim 35, wherein the polyethylene resin includes polyethylene and ethylene copolymers of C₃ to C₁₀ alpha-olefins.

39. A polyethylene product prepared from the polyethylene resin of claim 35.

40. A blow-molded article made from the polyethylene resin of claim 35.
